(19) United States
(12) Patent Application Publication
(10) Pub. No.: US 2025/0199133 A1
(43) Pub. Date: Jun. 19, 2025

(54) TRANSCEIVING ASSEMBLY OF LIDAR DEVICE, AND LIDAR DEVICE

(71) Applicant: BEIJING MORELITE SEMICONDUCTOR CO., LTD., Beijing (CN)

(72) Inventors: Yunsong WANG, Beijing (CN); Guomin JIANG, Beijing (CN); Zhongyu LI, Beijing (CN)

(21) Appl. No.: 19/072,083

(22) Filed: Mar. 6, 2025

Related U.S. Application Data
(63) Continuation of application No. PCT/CN2022/142578, filed on Dec. 28, 2022.

(30) Foreign Application Priority Data
Sep. 9, 2022 (CN) 202211098509.5

(51) Int. Cl. G01S 7/481; G01S 17/58

(52) U.S. Cl. CPC G01S 7/4818; G01S 17/58

(57) ABSTRACT

A transceiving assembly (300) of a LiDAR device and a LiDAR device (10) are provided. The transceiving assembly (300) comprises: a rear-end component (310) comprising integrated optical units (300n), each of which comprises a first interface (315) configured to transmit a detection optical signal and a reflected optical signal through the optical units (300n); and a front-end component (330) coupled with the rear-end component (310) and configured to receive and transmit the detection optical signal from the rear-end component (310) and receive the reflected optical signal from a detection environment and transmit the reflected optical signal to the rear-end component (310), wherein the front-end component (330) can change the spatial distribution of the detection optical signal according to the requirements of the detected environment. In this way, the flexibility and compatibility of the LiDAR device can be improved.

### CROSS-REFERENCE TO RELATED APPLICATION

This disclosure is a continuation of PCT application No. PCT/CN2022/142578 filed on Dec. 28, 2022, which claims the priority of Chinese Patent Application No. 202211098509.5, field in China Sep. 9, 2022, the disclosure of which is hereby incorporated by reference in its entirety.

### TECHNICAL FIELD

The present application relates to the technical field of Light Detection Ad Ranging (LiDAR), and in particular, to a transceiving assembly of a LiDAR device and a LiDAR device.

### BACKGROUND

Light Detection And Ranging (LiDAR) systems have been widely used in the fields of obstacle detection, distance measurement, and related applications, such as autonomous driving and obstacle avoidance for intelligent robots. A LiDAR device transmits a laser pulse and receives a reflected laser pulse reflected back from a surrounding object, calculates the distance from the LiDAR device to the surrounding object based on the time delay between the transmitted laser pulse and the reflected laser pulse. The LiDAR device can perform 360-degree rotating and scanning within the entire scene to obtain obstacle information around the device.

Existing LiDAR devices generally include multiple light-emitting channels. Parameters such as relative positions and angles of these channels cannot be modified or adjusted after installation. When new requirements arise, the LiDAR device must be redesigned, which requires significant time investment.

### SUMMARY

An object of the present application is to provide a transceiving assembly of a LiDAR device and a LiDAR device, which can improve flexibility and compatibility of a LiDAR device.

A transceiving assembly, based on an optical chip, of a Light Detection And Ranging (LiDAR) device is provided. The transceiving assembly includes: a rear-end component, including a plurality of optical units that is integrated, each of the optical units including a first interface configured to respectively transmit a detection optical signal and a reflected optical signal through the plurality of optical units; one or more front-end components detachably coupled to the rear-end component and configured to receive and emit the detection optical signal transmitted by the rear-end component, and receive the reflected optical signal from a detected environment and transmit the reflected optical signal to the rear-end component, wherein the one or more front-end components are capable of changing a spatial distribution of the detection optical signal according to requirement of the detected environment.

In some embodiments, the one or more front-end components include a plurality of second interfaces corresponding to the first interface, and the plurality of second interfaces is detachably coupled to the first interface of the rear-end component through the plurality of second interfaces.

In some embodiments, the one or more front-end components include a plurality of third interfaces corresponding to the plurality of second interfaces, and the plurality of third interfaces is away from the first interface relative to the plurality of second interfaces; and the plurality of third interfaces has a plurality of spatial distribution modes, so as to change the spatial distribution of the detection optical signals according to the requirement of the detected environment.

In some embodiments, the plurality of spatial distribution modes includes a one-dimensional pattern and a two-dimensional pattern.

In some embodiments, the one-dimensional pattern includes a linear pattern or a curved line pattern; and/or the two-dimensional pattern includes a planar pattern or a curved surface pattern.

In some embodiments, the plurality of third interfaces is distributed on one side of the one or more front-end components in a uniform distribution; or the plurality of third interfaces is distributed on one side of the one or more front-end components in a distribution that third interfaces at a central position are dense and third interfaces at an edge position is sparse.

In some embodiments, the plurality of second interfaces and the plurality of third interfaces are coupled through an optical fiber.

In some embodiments, the one or more front-end components include a first front-end component and a second front-end component, the plurality of second interfaces is disposed at the first front-end component, and the plurality of third interfaces is disposed at the second front-end component.

In some embodiments, the first front-end component and the second front-end component are separately disposed, and the plurality of second interfaces and the plurality of third interfaces are coupled through an optical fiber.

In some embodiments, the one or more front-end components and the rear-end component are coupled in at least one of following manners: end surface coupling, lens coupling, vertical coupling, or optical bonding-wire coupling.

In some embodiments, the rear-end component includes one or more of following: a silicon optical chip, a III-V group optical chip, or a lithium niobate optical chip.

In some embodiments, the one or more front-end components includes one or more of following: a planar optical waveguide chip, an optical fiber array, or a micro lens array.

In some embodiments, the planar optical waveguide chip includes a chip formed based on silicon, silicon oxynitride or a high polymer on an insulator.

In some embodiments, the optical fiber array includes: a V-shaped groove substrate; and an array optical fiber disposed on the V-shaped groove substrate at a preset interval.

In some embodiments, each micro lens in the micro lens array is disposed corresponding to the first interface.

A Light Detection And Ranging (LiDAR) device is further provided. The LiDAR device includes: the transceiving assembly according to any one of the foregoing claims; a laser light source configured to generate a laser beam having one or more wavelengths, wherein the laser beam is periodically modulated in a predetermined mode; and an optical distribution network configured to receive the laser beam and form a plurality of sub-beams, and allocate the plurality of sub-beams to the transceiving assembly.

The embodiments of the present application have the following technical effects: the transceiving assembly of the LiDAR device and the LiDAR device provided in this embodiment of the present application include a rear-end component and one or more front-end components that are detachably connected to each other, and through a combination of the one or more front-end components and the rear-end component, the FOV, the light emission angle, the channel spacing distribution, and the like of the multi-channel LiDAR device can be flexibly changed; and the rear-end component serves as a core component, can be independently iterated and improved, does not affect the design of the whole system, and the one or more front-end components can be flexibly compatible with the rear-end component, so that the flexibility and compatibility of the LiDAR device can be improved.

### BRIEF DESCRIPTION OF THE DRAWINGS

The accompanying drawings, which are incorporated herein and constitute a part of this specification, illustrate certain embodiments consistent with the present disclosure. These drawings, together with the detailed description, serve to explain the principles of the present disclosure. It is obvious that the following drawings used in the description are only part of the embodiments of the present application. Those skilled in the art may obtain other drawings according to these drawings without paying creative labors.

FIG. 1 is a schematic diagram of a laser modulation waveform according to some embodiments of the present disclosure.

FIG. 2 is a schematic structural diagram of a LiDAR device according to some embodiments of the present disclosure.

FIG. 3 is a schematic structural diagram of a transceiving assembly of a LiDAR device according to some embodiments of the present disclosure.

FIG. 4 is a schematic structural diagram of a transceiving assembly of a LiDAR device according to some embodiments of the present disclosure.

FIG. 5 is a schematic diagram of a mode multiplexing apparatus according to some embodiments of the present disclosure.

FIG. 6 is a schematic diagram of a mode multiplexing apparatus according to other embodiments of the present application.

FIG. 7 is a schematic structural diagram of a transceiving assembly of a LiDAR device according to some embodiments of the present disclosure.

FIG. 8 is a schematic structural diagram of a transceiving assembly of a LiDAR device according to some embodiments of the present disclosure.

FIG. 9 is a schematic structural diagram of a transceiving assembly of a LiDAR device according to some embodiments of the present disclosure.

FIG. 10 is a schematic structural diagram of a transceiving assembly of a LiDAR device according to some embodiments of the present disclosure.

### DETAILED DESCRIPTION

To clarify the objectives, technical solutions, and advantages of the present application, the following provides a detailed description of the present application with reference to the accompanying drawings. It is noted that the described embodiments are merely some but not all of the embodiments of the present application. All other embodiments obtained by a person of ordinary skill in the art based on the embodiments of the present application without creative efforts shall fall within the protection scope of the present application.

The terms used in the embodiments of the present application are merely for the purpose of describing specific embodiments, and are not intended to limit the present application. As used in the embodiments of the present application and the appended claims, the singular forms “a”, “this” and “the” are also intended to include plural forms, unless the context clearly indicates other meanings, and “a plurality of” generally includes at least two.

It should be understood that the term “and/or” used herein is merely an association relationship describing associated objects, indicating that three relationships may exist, for example, “A and/or B” may indicate that A exists alone, A and B exist simultaneously, and B exists alone. In addition, the character “/” in this specification generally indicates an “or” relationship between the associated objects.

It should be understood that although the terms first, second, third, etc. may be used in the embodiments of the present application, these terms should not be limited to these. These terms are only used to distinguish them. For example, without departing from the scope of the embodiments of the present application, the first may also be referred to as the second, and similarly, the second may also be referred to as the first.

It should also be noted that the terms “include”, “comprise” or any other variations thereof are intended to cover a non-exclusive inclusion, so that a commodity or device including a series of elements not only includes those elements, but also includes other elements not explicitly listed, or further includes elements inherent to such a commodity or device. Without more restrictions, an element defined by the phrase “including a” does not exclude the presence of additional identical elements in the commodity or device that includes the element.

Optional embodiments of the present application are described in detail below with reference to the accompanying drawings.

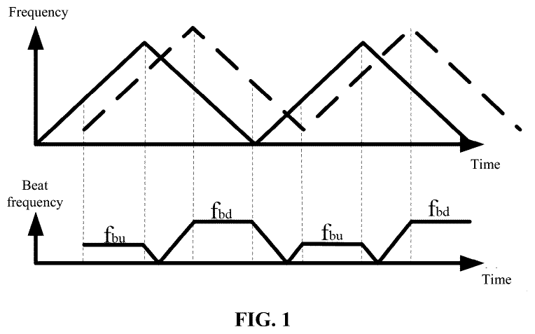

An embodiment of the present invention provides a Light Detection And Ranging (LiDAR) device. The LiDAR device may be a frequency modulated continuous wave (FMCW) LiDAR device, where the FMCW (Frequency Modulated Continuous Wave) device operates as follows: a detection laser emitted by a laser light source is modulated to form a modulated laser having a periodic pattern, for example, modulated into a laser with a triangular wave pattern, a sawtooth wave pattern, etc.; a modulated frequency of the modulated laser may change over time, for example, change as the triangular wave shown in FIG. 1, to implement a triangular-wave transmission signal after being modulated, wherein the solid lines represent the triangular-wave transmission signal; and the dashed lines represent a reflected signal. Frequency-modulated light may include a first half cycle with an optical frequency increasing with time and a second half cycle with an optical frequency decreasing with time. The LiDAR device emits the frequency-modulated light, which is reflected from the surface of a target object after a period of time, and the reflected light is received by the LiDAR device.

When the target object is moving away from the FMCW LiDAR, a transmitted triangular-wave modulation signal (solid lines), a reflected signal (dashed lines) and a measured beat frequency signal are shown in FIG. 1, and it can be seen that a beat frequency signal fbu in a frequency-increasing stage and a beat frequency signal fba in a frequency-decreasing stage measured by a balance detector are all positive values. After studying the measured beat frequency signal fbu in the frequency-increasing stage, as shown in FIG. 1, when the target object is relatively close to the FMCW LiDAR device and a movement speed V of the target object relative to the FMCW LiDAR device becomes faster and faster, the beat frequency signal fbu in the frequency-increasing stage is continuously reduced until reaching 0 due to the Doppler effect, and when the speed V increases continuously, the beat frequency signal fou in the frequency-increasing stage becomes greater than 0 and gradually becomes larger. The speed and the distance of the target object relative to the LiDAR device may be calculated by using the following formula:

$$\begin{matrix}D = \frac{c \cdot {t}_{s}}{2 {f}_{DEV}} ( {f}_{bu} + {f}_{bd} ) \\ V = \frac{c}{4 {f}_{DEV}} ( {f}_{bd} - {f}_{bu} )\end{matrix}$$

where C is the speed of light (a constant), tₛ is half of the period of a frequency modulation wave generated by a frequency generator, f_{DEV} is a frequency-sweeping bandwidth of the frequency modulation wave, f_{bu} is the beat frequency signal in the frequency-increasing stage, f_{bd} is the beat frequency signal in the frequency-decreasing stage, D is the distance between the target object and the LiDAR device, and V is the speed of the target object relative to the LiDAR device.

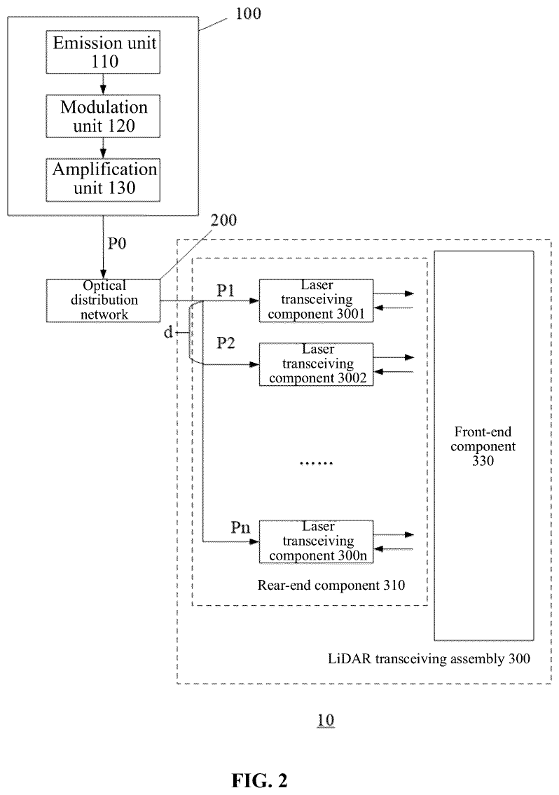

FIG. 2 shows a LiDAR device 10 including a laser transceiving assembly 300 provided in this embodiment, and the LiDAR device 10 includes a laser light source 100, an optical distribution network 200, and a laser transceiving assembly 300.

The laser light source 100 may be integrated on the laser transceiving assembly 300, or may be disposed outside the laser transceiving assembly 300, for example, laser light emitted by the laser light source 100 is coupled to the laser transceiving assembly 300 through an optical fiber or other optical components. The laser light source 100 is configured to generate a laser beam having one or more wavelengths, the laser light source 100 includes a laser emission unit 110, a laser modulation unit 120, and a laser amplification unit 130, and the laser emission unit 110 disposed outside the chip of the laser transceiving assembly 300 may be a distributed feedback laser, a fiber laser, a semiconductor laser, or the like, and the laser emission unit 110 integrated on the chip of the laser transceiving assembly 300 may be a hybrid integrated InP laser and an InGaAs laser. The laser modulation unit 120 is configured to periodically modulate the laser beam in a predetermined pattern, such as in a triangular wave or sawtooth wave pattern, and triangular-wave periodic modulation may be a pattern of a symmetric triangular wave or an asymmetric triangular wave. The laser amplification unit 130 may include an amplifier such as an erbium-doped fiber amplifier and a semiconductor optical amplifier, and amplify an optical signal generated by the laser light source to obtain a transmitted optical signal with sufficient energy.

The optical distribution network 200 is configured to receive the laser beam emitted by the laser light source 100 and form a plurality of sub-beams, and respectively allocate the plurality of sub-beams to the plurality of optical channels. The optical distribution network 200 may be integrated on the laser transceiver component 300 or outside the laser transceiver component 300. The optical distribution network 200 may be an optical power distribution network, and divide a received laser beam with a total power of P₀ into n optical branches with powers P₁, P₂, . . . , and Pn respectively. Each optical branch are input into one optical channel; the optical distribution network 200 may also be a wavelength division multiplexing network, laser containing m wavelengths received by the optical distribution network 200 is decomposed into m optical branches, each optical branch includes a laser sub-beam with a wavelength, and each wavelength of the laser sub-beam is input into one optical channel for wavelength selection according to requirements of the detected environment, for example, a 1064 nm infrared laser is selected for detection in the atmospheric environment, 456 nm blue light is selected for underwater detection, or a combination of the two wavelengths is selected for complex environment detection. In some embodiments, the optical distribution network 200 is a wavelength-division multiplexing network, and each output port of the wavelength division multiplexing network correspondingly outputs a sub-beam of one wavelength.

In some embodiments, the optical distribution network 200 is further configured to be able to dynamically adjust the power of the sub-beam allocated to each of the optical channels. For example, the power of the sub-beam on each optical channel is dynamically adjusted by setting at least one optical power adjusting unit, so that the powers of the sub-beams on the optical channels are the same or different, so as to meet the laser detection requirement on each optical channel, for example, the laser power of two optical channels at the edge is adjusted to be strong, and is used for detecting a farther distance; the laser power of the intermediate optical channels is adjusted to be weak, so as to avoid crosstalk between the optical channels; or the laser power of the odd-numbered optical channels is adjusted to be strong, the laser power of the even-numbered optical channels is adjusted to be weak, and optical crosstalk between adjacent optical channels is further avoided.

In some embodiments, the optical distribution network 200 includes any of a thermo-optical switch network, an electro-optical switch network, a star coupler, or a cascaded multimode interferometer network. The optical distribution network is configured to select one or more of the optical channels to enable connectivity of the selected one or more optical channels. For example, the odd-numbered optical channels are selected to enable connectivity and transmit or receive laser, connectivity of the even-numbered optical channels is disabled and the even-numbered optical channels do not transmit or receive laser, and optical crosstalk between adjacent optical channels is further avoided; or the connectivity of the two optical channels at the edge can be enabled, so as to transmit or receive the laser, the connectivity of optical channels in the middle are disabled, and interference between the optical channels is avoided. For example, connectivity of each of the odd-numbered optical channels is enabled, a laser with a specified wavelength can be transmitted or received by the odd-numbered optical channels; connectivity of each of the even-numbered optical channels is disabled, a laser with a specified wavelength is not transmitted or received by the even-numbered optical channels, and it is further possible to select, according to requirements, light of a desired wavelength for emission, so as to meet the requirements of laser detection in a complex environment. Optionally, the laser with the specified wavelength and/or the specified power of the specified optical channel is selected to be output, so as to meet the requirements of laser detection under specific conditions, and specific selection can be controlled by the optical distribution network according to the needs of application scenarios, which will not be repeated here.

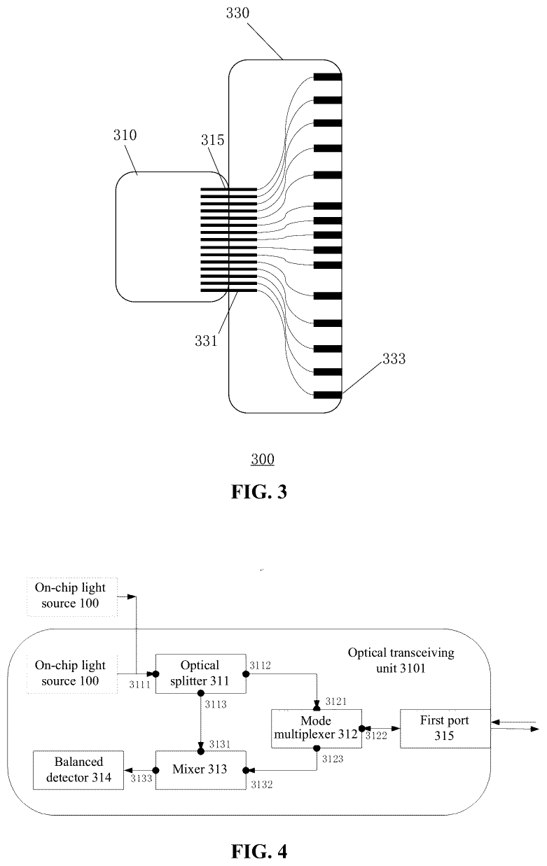

As shown in FIG. 3, the laser transceiving assembly 300 provided in this embodiment includes a rear-end component 310 and a front-end component 330, and the front-end component 330 is detachably coupled to the rear-end component 310.

The rear-end component 310 includes plurality of optical units that are integrated, the plurality of optical units may be a plurality of optical transceiving units 300n shown in FIG. 2, each of the optical units includes a first interface 315 configured to transmit a detection optical signal and a reflected optical signal through the plurality of optical units, and the first interface 315 may be a structure such as an optical coupling lens or a lens group or an optical fiber coupling interface. The rear-end component 310 is coupled to the optical distribution network 200 to transmit and receive multiple detection optical signals.

The front-end component 330 receives and transmits the detection optical signal transmitted from the rear-end component 310, and receives the reflected optical signal from the detected environment and transmits the reflected optical signal to the rear-end component 310. The front-end component 330 includes a plurality of second interfaces 331 disposed corresponding to the first interfaces 315, each of the plurality of second interfaces 331 may also be an optical coupling lens or a lens group or an optical fiber coupling interface, and the front-end component 330 is detachably coupled to the first interfaces 315 of the rear-end component 310 through the plurality of second interfaces 331, and after being coupled, each first interface 315 is optically connected to the corresponding second interface 331 of the plurality of second interfaces, and the coupling may include the following: end-surface coupling, lens coupling, vertical coupling, optical bonding, or wire coupling.

The front-end component 330 can change the spatial distribution of the detection optical signal according to the requirements of the detected environment. Specifically, the front-end component 330 includes a plurality of third interfaces 333 disposed corresponding to the plurality of second interfaces 331, each of the plurality of third interfaces 333 may also be an optical coupling lens or a lens group, and the plurality of third interfaces 333 is disposed away from the first interfaces 315 relative to the plurality of second interfaces 331. The plurality of third interfaces 333 has a plurality of spatial distribution patterns to change the spatial distribution of the detection optical signals according to the requirements of the detected environment. The spatial distribution pattern of the detection optical signals includes a one-dimensional pattern and a two-dimensional pattern. The one-dimensional pattern includes a linear pattern or a curved line pattern, the linear pattern is that the detection optical signals are distributed along one straight line, the curved line pattern is that the detection optical signals are distributed along a curve, for example, a parabola, a hyperbolic curve and the like, and the field of view (Field of View, FOV) can be increased through the curved line pattern to meet the requirement of the maximum detection FOV in a micro device. The two-dimensional pattern includes a planar pattern and a curved surface pattern. The planar pattern is that the detection optical signals are distributed in a plane. The curved surface pattern is that the detection optical signals are distributed on a curved surface, for example, a spherical surface, a paraboloid, a hyperboloid, etc. the field of view can be further increased by setting a curved-surface two-dimensional space, and the requirement of the maximum FOV can be further met in a micro device.

In some embodiments, the plurality of third interfaces 333 are evenly distributed on one side of the front-end component 330 at intervals. In some embodiments, as shown in FIG. 3, the plurality of third interfaces 333 may also be unevenly distributed on one side of the front-end component 330, for example, distributed on one side of the front-end component 330 in a pattern that the third interfaces 333 in the middle are dense and the third interfaces 333 at the edge are sparse, so as to meet the requirement of detection of an intermediate target position in the detected environment. In some embodiments, as shown in FIG. 3, the plurality of second interfaces 331 and the plurality of third interfaces 333 are coupled through optical fibers, the optical fibers have flexibility, and the positional relationship between the plurality of second interfaces 331 and the plurality of third interfaces 333 can be flexibly configured.

In some embodiments, the plurality of optical units included in the rear-end component 310 are a plurality of optical transceiving units (3101, 3102, . . . , 310n), the plurality of optical transceiving units are configured to detect an obstacle based on the sub-beams, each of the optical transceiving units is optically connected to the corresponding optical channel, the laser light generated by the laser light source 100 is distributed into N channels of laser light through the optical distribution network 200, the N channels of laser light are respectively transmitted to the laser transceiving assembly 300 integrated with N transceiving channels, so as to form N transceiving optical paths to detect objects in the environment and detect the distance and/or the speed of the objects, where N is a natural number greater than 1, and optionally N is a natural number of a value 1-16. In some embodiments, the rear-end component 310 may be selected from a silicon optical chip, a III-V group optical chip, a lithium niobate optical chip, and the like.

In some embodiments, as shown in FIG. 4, a laser transceiving apparatus 3101 (with the same structure as the laser transceiving assembly) includes an optical splitter 311, a mode multiplexer 312, a mixer 313, a balanced detector 314, and a first interface 315 that are optically connected, and the optical connection may be an optical transmission medium connection such as an optical fiber and an optical waveguide.

The optical splitter 311 includes three ports, wherein a first port 3111 of the optical splitter receives a laser sub-beam input from the optical distribution network 200, and divides the sub-beam into a first sub-beam and a second sub-beam through the optical splitter 311; the first sub-beam is transmitted to the mode multiplexer 312 through a second port 3112 of the optical splitter as a detection laser signal, and the second sub-beam is transmitted to the mixer 313 through the third port 3113 of the optical splitter as a local-oscillation laser signal.

Optionally, a power allocation ratio of the local-oscillation laser signal to the detection laser signal may be fixed, for example, the power allocation ratio of the local-oscillation laser signal to the detection laser signal is 3:7. The power allocation ratio of the local-oscillation laser signal to the detection laser signal may also be adjustable. For example, when the detection target distance is slightly far, the power of the detection laser signal should be properly increased, but the power of the local-oscillation laser signal should meet the minimum threshold of mixing the local-oscillation laser signal and the detection laser signal, for example, the power allocation ratio of the local-oscillation laser signal to the detection laser signal is adjusted to 1:9, and the power of the local-oscillation laser signal meets a minimum threshold, for example, 1 mW, which is not specifically limited.

In some embodiments, the optical splitter 311 includes any one of following: a directional coupler, an asymmetric multimode interferometer, a Y-type optical splitter, an adiabatic optical splitter, a thermo-optical switch, or an electro-optical switch. The selection of any device may be selected and applied according to factors such as the power and wavelength of the laser transmission signal distributed by the optical distribution network, which will not be repeated here.

The mode multiplexer 312 includes three ports, wherein the first port 3121 of the mode multiplexer is in optical connection with the second port 3112 of the optical splitter and is configured to receive the first sub-beam and then transmit the first sub-beam to the second port 3122 of the mode multiplexer, the first sub-beam is transmitted as a detection laser signal through the second port 3122 of the mode multiplexer, the second port 3122 of the mode multiplexer receives a first detection beam formed after the first sub-beam is reflected by the object in the environment, and transmits the reflected first detection beam to the third port 3123 of the mode multiplexer, optical characteristics of the first sub-beam and the first detection beam formed after reflection are different. The mode multiplexer 312 can only enable the first sub-beam with the first mode to be transmitted from the first port 3121 of the mode multiplexer to the second port 3122 of the mode multiplexer, and the mode multiplexer 312 can only enable the first detection beam with the second mode to be transmitted from the second port 3122 of the mode multiplexer to the third port 3123 of the mode multiplexer and cannot be transmitted to the first port 3121 of the mode multiplexer, that is, the first sub-beam and the first detection beam are different in mode, and optionally, the polarization directions of the first sub-beam and the first detection beam are different, for example, O-light or E-light; or the optical modes of the first sub-light beam and the first detection light beam are different, for example, a transverse electric mode or a transverse magnetic mode.

In some embodiments, the mode multiplexer includes a polarization mode multiplexer; wherein the polarization mode multiplexer includes at least one of a polarization optical splitter based on a coupling waveguide, a polarization optical splitter based on a sub-wavelength grating structure, a polarization optical splitter based on a multi-mode interference structure, a polarization optical splitter based on a groove-type waveguide, or a polarization optical splitter of a base composite waveguide; by using the waveguide polarization mode multiplexer, the integration degree of the device can be improved while non-interfering unidirectional transmission of the laser can be ensured, so that the overall size of the laser transceiving assembly is reduced, and the optical channel can still transmit optical signals without interfering with each other within the range of 20-100 microns.

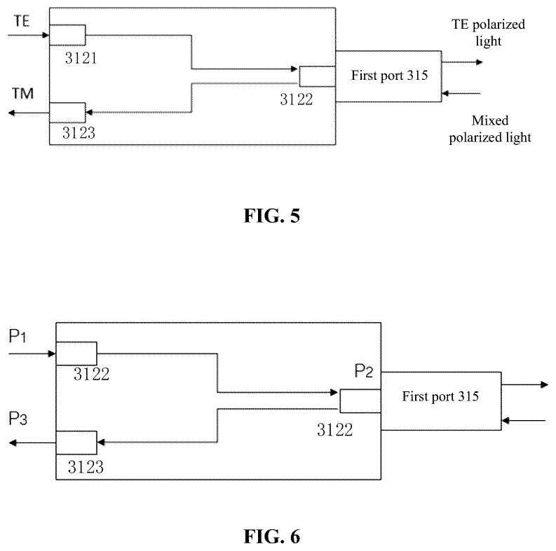

In some embodiments, the mode multiplexer includes a mode converter; as shown in FIG. 5, in the mode converter, an optical mode of the first sub-beam is TEn or TMn mode, an optical mode of the first detection beam is a TEm or TMm mode, n≠m, and n and m are natural numbers greater than 3. With the above-mentioned mode converter, since the optical modes change, it can be ensured that uni-directional transmission of the laser beams is implemented without interfering with each other, the size of the device is reduced, the integration level of the device is improved, the overall size of the laser transceiving assembly is reduced, and the optical channels can still transmit optical signals without interfering with each other within the range of 20-100 microns.

In some embodiments, the mode multiplexer includes a non-reciprocal mode multiplexer, as shown in FIG. 6. The non-reciprocal mode multiplexer includes at least one of following: a non-reciprocal mode multiplexer based on a yttrium iron garnet magnetic optical waveguide, a non-reciprocal mode multiplexer based on an optical nonlinear effect, or a non-reciprocal mode multiplexer based on time-space modulation. The detection light beam and the reflected light beam have has different losses in a transmission process from port 1 to port 2 and a transmission process from port 2 to port 1, so that the non-reciprocal ratio of the optical non-reciprocal mode multiplexer can be obtained. The non-reciprocity of the non-reciprocal mode multiplexer is represented by differences between the losses of forward and reverse propagation paths. The loss from the first port 3121 to the second port 3122 during forward propagation tis small, the loss from the second port 3122 to the first port 3121 during reverse propagation is large, and the loss from the second port 3122 to the third port 3123 is very small, so that the outgoing laser beam and the return laser beam may be transmitted in their respective paths without interfering with each other. By using the non-reciprocal mode multiplexer, the integration degree of the device can be improved while non-interfering unidirectional transmission of the laser can be ensured, so that the overall size of the laser transceiving assembly is reduced, and the optical channel can still transmit optical signals without interfering with each other within the range of 20-100 microns.

The mixer 313 includes three ports, and the first port 3131 of the mixer is in optical connection with the second port 3112 of the optical splitter and is configured to receive the second sub-beam; the second port 3132 of the mixer is in optical connection with the third port 3123 of the mode multiplexer, and is configured to receive the reflected first detection beam, and the second sub-beam and the first detection beam form a mixed beam to be output from the third port 3133 of the mixer, wherein the mixer 313 may be a directional coupler or a multimode interferometer.

The balanced detector 314 includes two ports, the input port of the balanced detector is optically connected to the third port 3133 of the mixer, configured to obtain the frequency difference between the second sub-beam and the first detection beam after receiving the mixed beam, and then output the frequency difference to the processor through the output port, and according to the above formula (4), the processor may calculate the distance and speed from the FMCW LiDAR system to the object.

The front-end component 330 is configured to change the size, position, angle of an optical channel, and/or change the angular distribution and spacing distribution between the optical channels. The front-end component 330 includes second interfaces 331 for optical path connection with the rear-end component 310, and specifically, the plurality of second interfaces 331 are in optical path connection with the first interfaces 315 of the rear-end component 310. In some embodiments, the front-end component 330 may be selected from a planar optical waveguide (PLC) chip, an optical fiber array (FA), and a micro lens array.

In some embodiments, the front-end component 330 is a planar optical waveguide chip, and the planar optical waveguide chip includes an optical device based on a planar optical path technical solution, such as silicon (SOI SIMOX), silicon oxynitride, or polymer (Polymer) on an insulator.

In some embodiments, the front-end component 330 is an optical fiber array, and the optical fiber array refers to an array formed by mounting a bundle of optical fibers or an optical fiber ribbon on a substrate at specified intervals by using a V-shaped groove (i.e. a V-Groove) substrate, and specifically, the optical fiber array comprises: a V-shaped groove substrate and an array optical fiber disposed on the V-shaped groove substrate at a preset interval.

In some embodiments, the front-end component 330 is a micro-lens array, and each micro-lens in the micro-lens array is disposed corresponding to the first interface.

In some embodiments, referring to FIG. 3, the spacing distribution of the optical channels may be changed by using the front-end component 330, so that different regions such as dense areas and sparse areas with different spacings are distributed in the field of view of the LiDAR device, so that the spacing distribution of the optical channels can be adjusted according to the actual situation of the environment, and the scanning flexibility of the LiDAR device is improved.

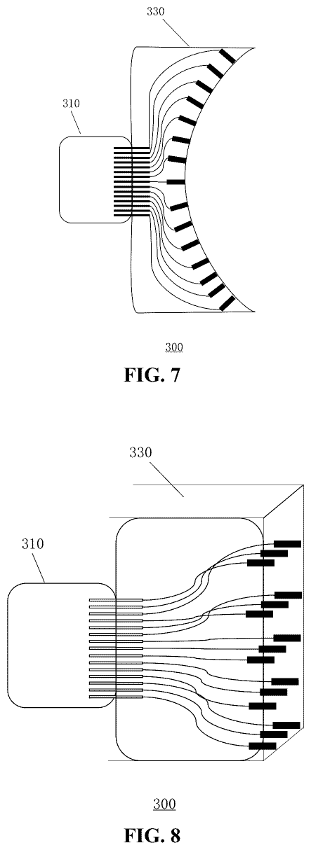

In some embodiments, referring to FIG. 7, the front-end component 330 may be used to enable the optical channels to be distributed along an arc shape, for example, an arc structure with an arc or other curvature. In this example, the front-end component 330 may change the light-emitting angles of the optical channels, so that the light-emitting angles are distributed along the arc, so that a target at a certain position, such as a central target of an arc, can be detected in a centralized manner, thereby providing a more accurate detection result. Further, the front-end component 330 may further change the light-emitting positions of the optical channels on this basis, for example, the plurality of third interfaces may be uniformly or unevenly distributed on the end surface of the arc-shaped front-end component, so that the detection direction of the detection light beam is more flexible and diverse.

In some embodiments, referring to FIG. 8, the optical channels may be distributed along the two-dimensional plane by using the front-end component 330. In this example, the front-end component 330 may change the light-emitting positions of the optical channel, so that the optical channels extend from one-dimensional linear distribution to the two-dimensional planar distribution. Further, the front-end component 330 may further change the light-emitting angles of the channels on this basis, so that the distribution of the light beams is more flexible and diverse, so that the LiDAR device can transmit/receive the detection laser to the required direction or angle, so that the LiDAR device covers a wider detection range, and the above-mentioned linear array is expanded to the surface array, so that a wider target range can be transmitted at one time, and the detection efficiency of the LiDAR device is improved.

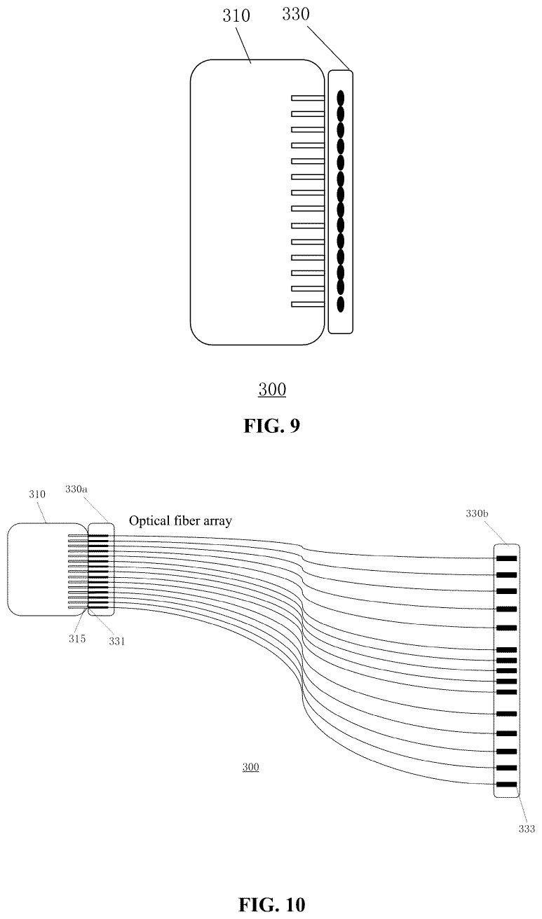

In some embodiments, referring to FIG. 9, the micro-lens array may be used as the front-end component 330, and the micro-lens array may change the light-emitting characteristic of the LiDAR device, for example, converge the dispersed external ambient light signals into the corresponding first interface. In some embodiments, the front-end component 330 may match a corresponding micro lens array parameter, for example, a focal length and a diameter of each lens, according to the layout of the first interface, so that the collimation characteristic of the channel is adapted according to needs.

In some embodiments, referring to FIG. 10, the front-end component further include a first front-end component 330a and a second front-end component 330b. The first front-end component 330a and the second front-end component 330b may be connected by using an optical fiber array. The plurality of second interfaces 331 are disposed on the first front-end component 330a, and the plurality of third interfaces 333 are disposed on the second front-end component 330b. In some embodiments, the first front-end component 330a and the second front-end component 330b are separately disposed, and the optical fiber array couples the plurality of second interfaces 331 of the first front-end component 330a to the plurality of third interfaces 333 of the second front-end component 330b. By using the optical fiber array, the second front-end component 330b and the rear-end component 310 may be disposed at a preset distance, for example, 1-10 meters, and may even be disposed in different locations, so that the layout of the LiDAR device may be more flexible. Especially when the plurality of third interfaces in the second front-end component 330b is a separable structure, the flexible configuration of the front-end components to the detected environment is further increased.

The transceiving assembly of a LiDAR device and the LiDAR device provided in this embodiment of the present application include a rear-end component and the front-end components that are detachably connected to each other. Through a combination of the front-end components and the rear-end component, the FOV, the light-emission angle, the channel spacing distribution, and the like of the multi-channel LiDAR device system can be flexibly changed; and the rear-end component serves as a core component, can be independently iterated and improved, does not affect the design of the whole system, and the one or more front-end components can be flexibly compatible with the rear-end component, so that the flexibility and compatibility of the LiDAR device can be improved.

Finally, it should be noted that the embodiments in the present specification are described in a progressive manner, each embodiment focuses on differences from other embodiments, and the same or similar parts between the embodiments can be referred to each other. Although the present application has been described in detail with reference to the foregoing embodiments, those of ordinary skill in the art should understand that they can still modify the technical solutions described in the foregoing embodiments or make equivalent replacements to some of the technical features thereof; and these modifications or replacements do not make the essence of the corresponding technical solutions depart from the spirit and scope of the technical solutions of the embodiments of the present application.

What is claimed is:

1. A transceiving assembly based on an optical chip, the transceiving assembly being of a Light Detection And Ranging (LiDAR) device, the transceiving assembly comprising:
a rear-end component, comprising a plurality of optical units that is integrated, each of the optical units comprising a first interface configured to respectively transmit a detection optical signal and a reflected optical signal through the plurality of optical units;
one or more front-end components detachably coupled to the rear-end component and configured to receive and emit the detection optical signal transmitted by the rear-end component, and receive the reflected optical signal from a detected environment and transmit the reflected optical signal to the rear-end component, wherein the one or more front-end components are capable of changing a spatial distribution of the detection optical signal according to requirement of the detected environment.

2. The transceiving assembly according to claim 1, wherein the one or more front-end components comprise a plurality of second interfaces corresponding to the first interface, and the plurality of second interfaces is detachably coupled to the first interface of the rear-end component through the plurality of second interfaces.

3. The transceiving assembly according to claim 2, wherein the one or more front-end components comprise a plurality of third interfaces corresponding to the plurality of second interfaces, and the plurality of third interfaces is away from the first interface relative to the plurality of second interfaces; and the plurality of third interfaces has a plurality of spatial distribution modes, so as to change the spatial distribution of the detection optical signals according to the requirement of the detected environment.

4. The transceiving assembly according to claim 3, wherein the plurality of spatial distribution modes comprises a one-dimensional pattern and a two-dimensional pattern.

5. The transceiving assembly according to claim 4, wherein the one-dimensional pattern comprises a linear pattern or a curved line pattern; and/or
the two-dimensional pattern comprises a planar pattern or a curved surface pattern.

6. The transceiving assembly according to claim 4, wherein the plurality of third interfaces is distributed on one side of the one or more front-end components in a uniform distribution; or
the plurality of third interfaces is distributed on one side of the one or more front-end components in a distribution that third interfaces at a central position are dense and third interfaces at an edge position is sparse.

7. The transceiving assembly according to claim 3, wherein the plurality of second interfaces and the plurality of third interfaces are coupled through an optical fiber.

8. The transceiving assembly according to claim 3, wherein the one or more front-end components comprise a first front-end component and a second front-end component, the plurality of second interfaces is disposed at the first front-end component, and the plurality of third interfaces is disposed at the second front-end component.

9. The transceiving assembly according to claim 8, wherein the first front-end component and the second front-end component are separately disposed, and the plurality of second interfaces and the plurality of third interfaces are coupled through an optical fiber.

10. The transceiving assembly according to claim 1, wherein the one or more front-end components and the rear-end component are coupled in at least one of following manners:
end surface coupling, lens coupling, vertical coupling, or optical bonding-wire coupling.

11. The transceiving assembly according to claim 1, wherein the rear-end component comprises one or more of following:
a silicon optical chip, a III-V group optical chip, or a lithium niobate optical chip.

12. The transceiving assembly according to claim 1, wherein the one or more front-end components comprises one or more of following:
a planar optical waveguide chip, an optical fiber array, or a micro lens array.

13. The transceiving assembly according to claim 12, wherein the planar optical waveguide chip comprises a chip formed based on silicon, silicon oxynitride or a high polymer on an insulator.

14. The transceiving assembly according to claim 12, wherein the optical fiber array comprises:
a V-shaped groove substrate; and
an array optical fiber disposed on the V-shaped groove substrate at a preset interval.

15. The transceiving assembly according to claim 12, wherein each micro lens in the micro lens array is disposed corresponding to the first interface.

16. A Light Detection And Ranging (LiDAR) device, comprising:
the transceiving assembly according to claim 1;
a laser light source configured to generate a laser beam having one or more wavelengths, wherein the laser beam is periodically modulated in a predetermined mode; and
an optical distribution network configured to receive the laser beam and form a plurality of sub-beams, and allocate the plurality of sub-beams to the transceiving assembly.
